(19) United States
(12) Patent Application Publication
(10) Pub. No.: US 2011/0023321 A1
(43) Pub. Date: Feb. 3, 2011

(54) DRYER AND CONTROL METHOD FOR SAME

(76) Inventor: Ki-Wook Jung, Gyeongsangnam-Do (KR)

Correspondence Address: BIRCH STEWART KOLASCH & BIRCH, PO BOX 747, FALLS CHURCH, VA, 22040-0747, US

(21) Appl. No.: 12/935,183

(22) PCT Filed: Jun. 2, 2009
(86) PCT No.: PCT/KR2009/002933

§ 371 Date: Sep. 28, 2010

(30) Foreign Application Priority Data
Jun. 3, 2008 (KR) 1020080052325

(51) Int. Cl. F26B 13/10

(52) U.S. Cl. 34/418; 34/527

(57) ABSTRACT

A dryer control method includes: a hot wind supply step in which hot wind is supplied to the dry items accommodated within the drum; an intermediate dry step in which the dry items are cooled and a hot wind supply to the cooled dry items is resumed; and a cooling step in which the hot wind supply is stopped and the dry items are cooled. Because the dry step is repeatedly performed on a dry item made of polyester fiber at short time intervals according to a proposed algorithm, a shrinkage of the dry item made of polyester fiber that may be otherwise generated in a general dry step can be prevented.

### TECHNICAL FIELD

The present invention relates to a dryer and its control method, and more particularly, to a dryer capable of preventing a dry item made of polyester accommodated within a drum from being severely shrunken because it is brought into contact with hot wind supplied to the interior of the drum for a long time by performing a dry item cooling process at least twice, and a control method thereof.

### BACKGROUND ART

In general, a dryer, a home appliance devised for drying the laundry, i.e., mainly the clothes, which have been washed, by using air, includes a drum for accommodating dry items, a driving source for drying the drum, a heating unit for heating air introduced into the drum, and a blower unit for sucking air from the interior of the drum or discharging it.

The dryer may be classified into various types according to a discrimination basis. First, the dryer may be classified into an electric dryer and a gas dryer according to how air is heated, namely, according to a heating unit. The electric dryer heats air by using electric resistance heat, and the gas dryer heats air by using heat generated by combustion of gas.

Also, the dryer may be classified into a condensation type dryer and an exhaustion type dryer according to how humid generated as dry items are dried is treated. In the condensation type dryer, air which has been humid as it heat-exchanged with the dry items in the drum is circulated, rather than being discharged to the outside, and a condenser is heat-exchanged with external air to create and discharge condensation water to the outside. In the exhaust type dryer, air which has been heat-exchanged with the dry item so as to include high moisture is directly discharged to the outer side of the dryer.

In addition, the dryer may be classified into a top loading type dryer and a front loading type dryer depending on how a dry item is input into the dryer. In the top loading type, a dry item is inputted from the upper side of the dryer, and in the front loading type, a dry item is inputted from a front side of the dryer.

The related art dryer is a device for drying dry items by using heat of high temperature irrespective of a classification type.

In this case, however, a time duration during which each dry item comes in contact with high temperature air needs to be different and an air temperature range should be different according to their types. Namely, if the air temperature or contact time duration are equal, the dry items might be severely thermally damaged or severely creased depending on the materials of the dry items, possibly causing a severe deformation of the dry items compared with those before the drying operation.

Thus, if the dry items accommodated within the drum of the related art dryer are fiber made of polyester, a time duration during which the dry item is exposed to hot wind at high temperature is very long, thermally damaging the dry item, and severely shrinking polyester clothes such as athletic wear.

### TECHNICAL GIST OF THE PRESENT INVENTION

Therefore, it is an object of the present invention to provide a dryer capable of preventing athletic wear such as fiber made of a polyester material from being shrunken or creased when being brought in contact with hot wind during a dry process, and its control method

It is another object of the present invention to provide a dryer capable of reducing a dry time duration of a dry item made of polyester material such as athletic wear by a half of a dry time duration of a general dry process, thus reducing energy consumption, and its control method.

To achieve the above objects, there is provided a dryer control method including: a dry step in which hot wind is supplied to the interior of a drum in which dry items are accommodated and cooling of the dry items is performed at least twice.

The dry step may include: a hot wind supply step in which hot wind is supplied to the dry items accommodated within the drum; an intermediate dry step in which the dry items are cooled and a hot wind supply to the cooled dry items is resumed; and a cooling step in which the hot wind supply is stopped and the dry items are cooled.

Each step may be controlled according to the temperature of the hold wind, and each step may include: detecting the temperature of hot wind discharged from the drum; and measuring an execution time duration of each step.

The hot wind supply step may be performed until such time as the detected hot wind temperature is increased up to a first reference temperature or until such time as the measured execution time duration reaches a first reference time.

The intermediate dry step may include: an intermediate cooling step performed until such time as the detected hot wind temperature is dropped to a second reference temperature or until such time as the measured execution time duration reaches a second reference time; and an intermediate hot wind supply step performed until such time as the detected hot wind temperature is increased up to a third reference temperature or the measured execution time duration reaches a third reference time. In this case, the intermediate dry step may be performed at least twice.

The cooling step may be performed until such time as the detected hot wind temperature is dropped to a fourth reference temperature or the measured execution time duration reaches a fourth reference time.

The dryer control method may further include: displaying at least one operation information among an overall operation time duration of the dryer, the temperature of the discharged hot wind, the execution time duration of each step, and the number of executions of each step.

In the dry step, in the occurrence of an abnormal operation at an early stage, a moisture removing step of interrupting the dry step and cooing the drum to remove moisture may be first performed.

To achieve the above objects, there is also provided a dryer, which includes a drum, a heater for generating hot wind, a blow fan for supplying hot wind, and a motor for driving the drum and the blow fan, including: a controller configured to control ON/OFF operation of the heater and the motor to supply hot wind to dry items accommodated within the drum and cooling the dry items.

The dryer may further include: a display unit configured to display at least one operation information of an overall operation time duration of the dryer, the temperature of the discharged hot wind, the execution time duration of each step, and the number of executions of each step.

According to exemplary embodiments of the present invention, because a dry step is repeatedly performed on a dry item made of polyester fiber at short time intervals according to a proposed algorithm, a shrinkage of the dry item made of polyester fiber that may be otherwise generated in a general dry step can be prevented.

### BRIEF DESCRIPTION OF THE DRAWINGS

FIG. 1 is a sectional view of a dryer according to an exemplary embodiment of the present invention;

FIG. 2 is a schematic block diagram of a controller of the dryer according to an exemplary embodiment of the present invention; and

FIG. 3 is a flow chart illustrating the process of a dryer control method according to an exemplary embodiment of the present invention.

### MODE FOR CARRYING OUT THE PREFERRED EMBODIMENTS

Exemplary embodiments of the present invention will now be described in detail with reference to the accompanying drawings.

In order to describe a dryer according to an exemplary embodiment of the present invention, a front loading type dryer, an electric type dryer and a condenser type drier will be taken as examples. However, the present invention is not limited thereto and can be also applicable to a top loading type dryer, a gas type drier, and the like.

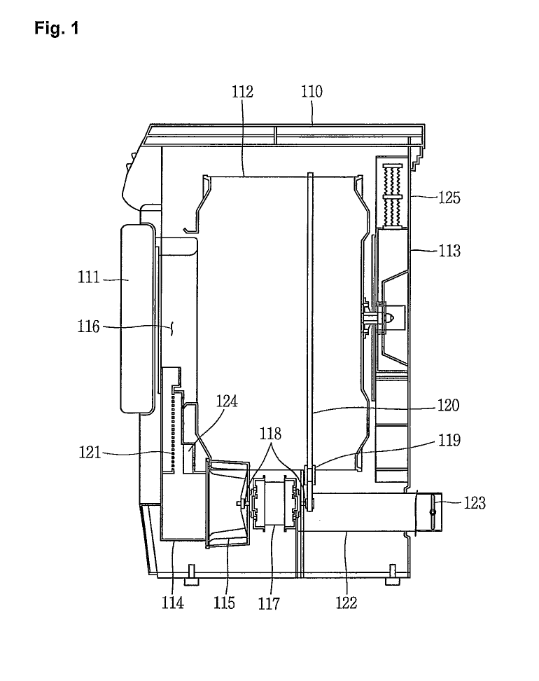

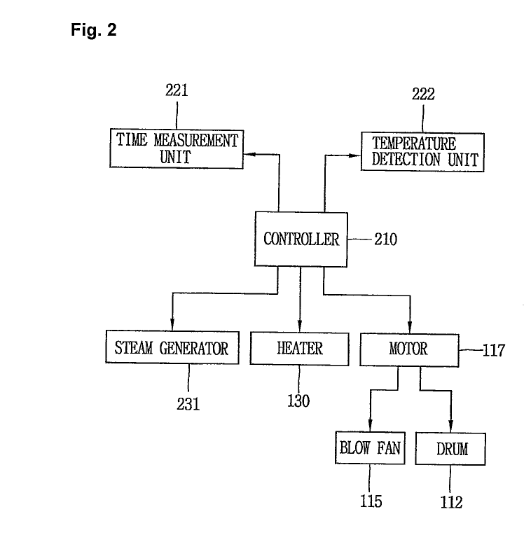

The dryer according to an exemplary embodiment of the present invention will now be described in detail with reference to FIGS. 1 and 2.

FIG. 1 is a sectional view of a dryer according to an exemplary embodiment of the present invention, and FIG. 2 is a schematic block diagram of a controller of the dryer according to an exemplary embodiment of the present invention.

As shown in FIG. 1, the dryer includes a cabinet 110 constituting an outer appearance of the dryer and having a door 111 formed on a front surface thereof, a drum 112 installed to be rotatable within the cabinet 110, a hot wind guide duct 113 for guiding hot wind into the drum 112, a hot wind discharge duct 114 for discharging hot wind which has passed through the interior of the drum 112, a blow fan 115 for sucking external air and discharging it, and a temperature detection unit 222 for detecting the temperature of hot wind discharged via the hot wind discharge duct 114.

An opening 16 is formed on the front surface of the cabinet 110 with the door 111 mounted thereon in order to allow clothes to be input into the drum 112 or taken out of the rum 112. The drum 112 is rotated at a low speed by a motor 117 installed at a lower portion of the cabinet 110. The motor 117 is provided to simultaneously drive the drum 112 and the blow fan 115, for which a driving shaft 118 of the motor 117 extends to both sides of the motor 117. One end of the driving shaft 118 is connected to the blow fan 115, and the other end is connected to a pulley 119 to rotate the drum 112. A belt 120, installed to cover the drum 112, is connected to the pulley 119.

The hot wind discharge duct 114 is disposed between a lower portion of the front surface of the drum 112 and the blow fan 115. A filter 121 is installed at one end of the hot wind discharge duct 114 to filter out debris such as nap or the like included in the hot wind which has passed through the drum 112. An exhaust duct 122 is formed as a cylindrical pipe at an outlet of the blow fan 115. An opening end of the exhaust duct 122 extends to outside of the cabinet 110. A switching valve 123 is installed at the opening end of the exhaust duct 122 to open the exhaust duct 122 by hot wind when the blow fan 115 is operated. When the blow fan 115 is not operated, the exhaust duct 122 is closed to prevent an introduction of debris from the exterior.

A heater unit 125 is installed at an upper portion of the hot wind guide duct 113. As the blow fan 115 and the drum 112 are rotated according to driving of the motor 117, external air, passing through the heater unit 125, is heated and introduced into the drum 112 via the hot wind guide duct 113. Accordingly, the clothes placed within the drum 112 is dried by the hot wind, and the hot wind which has passed through the drum 112 is discharged to the outside via the hot wind discharge duct 114 and the exhaust duct 122.

A steam generator (which is called a container heating method) that generates steam by heating a certain amount of water housed in a water tank (not shown) is installed at a certain position of the cabinet 110. However, in the present invention, any device can be used as a steam generator so long as it can generate steam. For example, a heater may be directly installed at the circumference of a water supply hose through which water passes, to heat water (which is called a tube heating method), rather than housing water in a certain space.

The controller 210 will now be described in detail with reference to FIG. 2.

The controller 210 is provided at a certain position of the dryer according to an exemplary embodiment of the present invention and controls the motor 117 and the heater 125 to adjust hot wind supply and cooling with respect to dry items. A time measurement unit 221 is provided to measure a time duration of a hot wind supply and cooling process. A temperature detection unit 222 is provided to detect the temperature of hot wind discharged from the drum 112.

The temperature detection unit 222 is provided at a certain position of the hot wind discharge duct 114 to detect the temperature of hot wind discharged through the hot wind discharge duct 114. The time measurement unit 221 measures a time duration during which hot wind generated by the heater unit 125 is supplied to the interior of the drum 112 and a time duration during which the dry items within the drum are cooled. The controller 210 controls the heater unit 125, the blow fan 115 and the motor 117 based on the information collected from various elements of the dryer including the detected temperature, the measured time duration, and the like, to thus control the operation of the dryer.

The temperature detection unit 222 detects the temperature of the hot wind discharged from the drum 112. The controller controls ON/OFF operation of the heater 125 according to the results obtained by determining whether or not the detected temperature is a value within a pre-set temperature range. The time measurement unit 221 measures a time duration during which the hot wind generated by the heater 125 is supplied to the interior of the drum 112. The controller 210 controls a processing procedure with respect to the dry items based on the results obtained by comparing the measured time duration or the detected temperature with the pre-set time duration or the pre-set temperature range.

In the present exemplary embodiment, the temperature detection unit 222 is positioned at the hot wind discharge duct 114, but without being limited thereto, the temperature detection unit 222 may be also provided at the hot wind guide duct 113 or the drum 112. More preferably, the temperature detection unit 222 is provided at the interior of the drum 112 to directly measure the internal temperature of the drum 112.

The dryer may include a control panel for receiving a dryer operation method according to a user selection and a display unit for displaying at least one operation information among an overall operation time duration of the dryer, the temperature of the discharged hot wind, the execution time duration of each step, and the number of executions of each step.

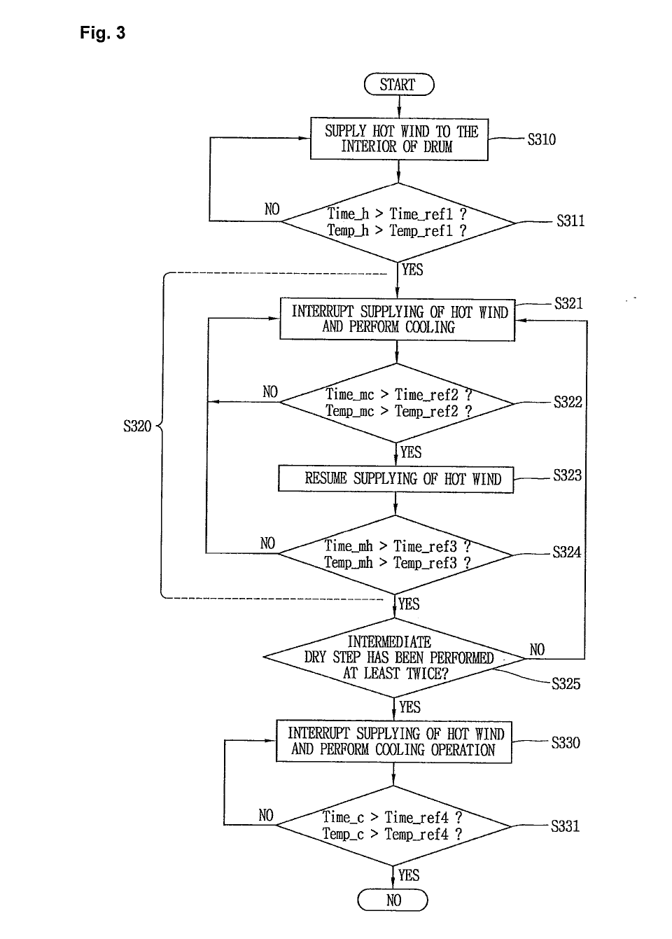

A dryer control method according to an exemplary embodiment of the present invention will now be described with reference to FIG. 3.

FIG. 3 is a flow chart illustrating the process of a dryer control method according to an exemplary embodiment of the present invention.

When a user inputs a dryer operation signal, the controller 210 controls the heater 130 to be turned on and the motor 117 to be forwardly rotated. As the motor 117 is rotated, the blow fan 115 is driven to supply hot wind generated by the heater 130 to the interior of the drum 112 (S310).

When hot wind is supplied to a dry item made of a polyester material such as athletic wear, the temperature detection unit 222 detects the temperature Temp_h of hot wind discharged from the drum and sends it to the controller 210. Also, the time measurement unit 221 measures a hot wind supply execution time duration (Time_h) during which hot wind is supplied to the interior of the drum, and sends it to the controller 221. The controller 210 compares the detected hot wind temperature and measured hot wind supply execution time duration with a pre-set reference temperature (Temp_ref1) and a reference time (Time_ref1), respectively. Upon comparison, if the detected hot wind temperature or measured hot wind supply execution time duration is higher than the reference temperature or longer than the reference time, the hot wind supply step (S310) is terminated and an intermediate dry step (S320), the next step, is performed.

Here, the reference temperature (Temp_ref1) is 59° C., and the reference time (Time_ref1) is fourteen minutes.

The intermediate dry step (S320) may include an intermediate cooling step (S321) in which the heater is turned off to stop supplying of hot wind and the dry items accommodated in the drum is cooled, and an intermediate hot wind supply step (S323) in which supply of hot wind to the cooled dry items is resumed to dry the dry items.

In the intermediate cooling step, the controller 210 compares a temperature (Temp_mc) of hot wind detected by the temperature detection unit 222 and a hot wind supply execution time duration (Time_mc) measured by the time measurement unit 221 with a pre-set reference temperature (Temp_ref2) and a reference time (Time_ref2), respectively (S322).

Upon comparison, if the hot wind temperature (Temp_mc) or the hot wind supply execution time duration (Time_mc) is higher than the pre-set reference temperature (Temp_ref2) or longer than the reference time (Time_ref2), the intermediate hot wind supply step (S323) is performed to resume supplying of hot wind.

Here, the reference temperature (Temp_ref2) is 53° C., and the reference time (Time_ref2) is one minute.

In the intermediate hot wind supply step S323, the heater is turned on to resume supplying of the hot wind which has been interrupted, and hot wind is again supplied to the dry items placed within the drum.

In the intermediate hot wind supply step, the controller 210 compares a temperature (Temp_mh) of hot wind detected by the temperature detection unit 222 and a hot wind supply execution time duration (Time_mh) measured by the time measurement unit 221 with a pre-set reference temperature (Temp_ref3) and a reference time (Time_ref3), respectively (S322).

Upon comparison, if the hot wind temperature (Temp_mh) or the hot wind supply execution time duration (Time_mh) is higher than the pre-set reference temperature (Temp_ref3) or longer than the reference time (Time_ref3), the controller 210 determines whether or not the intermediate dry step S320 has been performed at least twice (S325). According to the determination, if the intermediate dry step S320 has been performed twice or more times, the cooling step (S330), the next step, is performed, while if the intermediate dry step S320 has been performed less than twice, the intermediate dry step S320 is performed again.

Here, the reference temperature (Temp_ref3) is 59(C, and the reference time (Time_ref3) is two minutes.

The cooling step S330 is a process in which the dry items which have been brought into contact with high temperature air due to the resumed supply of hot wind.

In the cooling step S330, the controller 210 compares a temperature (Temp_c) of hot wind detected by the temperature detection unit 222 and a hot wind supply execution time duration (Time_c) measured by the time measurement unit 221 with a pre-set reference temperature (Temp_ref4) and a reference time (Time_ref4), respectively (S331).

Upon comparison, if the hot wind temperature (Temp_c) or the hot wind supply execution time duration (Time_c) is higher than the pre-set reference temperature (Temp_ref4) or longer than the reference time (Time_ref4), the controller 210 stops the cooling operation and terminates the entire dry step.

Each step may be controlled according to the temperature of hot wind. In this respect, in the present exemplary embodiment, in order to obtain accurate execution degree of each step, the values obtained by measuring the execution time duration and the temperature at the inner side of the drum measured at each step are used.

As so far described, the dryer control method according to the exemplary embodiments of the present invention has the advantages that the dry time of the dry item made of a polyester material such as athletic wear or the like can be reduced to a half compared with the dry time of the general dry process.

In the dry process, if the dryer is abnormally operated at an early stage, preferably, the moisture removing step of stopping the dry step and driving the drum to remove moisture is first performed.

The invention being thus described, it will be obvious that the same may be varied in many ways. Such variations are not to be regarded as a departure from the scope of the invention, and all such modifications as would be obvious to one skilled in the art are intended to be included within the scope of the following claims.

1-13. (canceled)

14. A dryer control method comprising:
a dry step in which hot wind is supplied to the interior of a drum in which dry items are accommodated and cooling of the dry items is performed at least twice,
wherein the dry step, in the occurrence of an abnormal operation at an early stage, a moisture removing step of interrupting the dry step and cooing the drum to remove moisture may be first performed.

15. The method of claim 14, wherein the dry step comprises:
a hot wind supply step in which hot wind is supplied to the dry items accommodated within the drum;
an intermediate dry step in which the dry items are cooled and a hot wind supply to the cooled dry items is resumed; and
a cooling step in which the hot wind supply is stopped and the dry items are cooled.

16. The method of claim 15, wherein each step is controlled according to the temperature of the hold wind.

17. The method of claim 15, wherein each step comprises:
detecting the temperature of hot wind discharged from the drum; and
measuring an execution time duration of each step.

18. The method of claim 17, wherein the hot wind supply step is performed until such time as the detected hot wind temperature is increased up to a first reference temperature or until such time as the measured execution time duration reaches a first reference time.

19. The method of claim 17, wherein the intermediate dry step comprises:
an intermediate cooling step performed until such time as the detected hot wind temperature is dropped to a second reference temperature or until such time as the measured execution time duration reaches a second reference time; and
an intermediate hot wind supply step performed until such time as the detected hot wind temperature is increased up to a third reference temperature or the measured execution time duration reaches a third reference time.

20. The method of claim 19, wherein the intermediate dry step is performed at least twice.

21. The method of claim 17, wherein the cooling step is performed until such time as the detected hot wind temperature is dropped to a fourth reference temperature or the measured execution time duration reaches a fourth reference time.

22. The method of claim 14, further comprising:
displaying at least one operation information among an overall operation time duration of the dryer, the temperature of the discharged hot wind, the execution time duration of each step, and the number of executions of each step.

23. A dryer comprising:
a drum;
a heater for generating hot wind;
a blow fan for supplying hot wind;
and a motor for driving the drum and the blow fan; and
a controller configured to control ON/OFF operation of the heater and the motor to supply hot wind to dry items accommodated within the drum and cooling the dry items.

24. The dryer of claim 23, further comprising:
a display unit configured to display at least one operation information of an overall operation time duration of the dryer, the temperature of the discharged hot wind, the execution time duration of each step, and the number of executions of each step.

25. The dryer of claim 23, wherein the dry item is a fiber made of a polyester material.
